(19) United States
(12) Patent Application Publication
(10) Pub. No.: US 2012/0260243 A1
(43) Pub. Date: Oct. 11, 2012

(54) Method for Operating a Computer Unit, Method for Operating an Application Portal, Computer Unit, Device for Operating an Application Portal and System

(75) Inventors: Simon Isenberg, Muenchen (DE); Thomas Helbig, Muenchen (DE); Mikhail Smirnov, Unterfoehring (DE)

(73) Assignee: Bayerische Motoren Werke Aktiengesellschaft, Muenchen (DE)

(21) Appl. No.: 13/440,440

(22) Filed: Apr. 5, 2012

(30) Foreign Application Priority Data
Apr. 6, 2011 (DE) 10 2011 006 898.8

(51) Int. Cl. G06F 9/44

(52) U.S. Cl. 717/169

(57) ABSTRACT

A computer unit has a browser is assigned a web application program cache and a configuration data file that specifies the web application programs storable in the cache and loadable from the cache without using an on-line connection to a communication network, in order to execute the web application programs. Update data for the configuration data file is read-in over an interface, assigned to the computer unit, and updates the configuration data file. A device for operating an application portal is configured such that the web application programs are selectable via the application portal. The programs are to be stored in a web application program cache. The device generates update data regarding the web application programs for the configuration data file as a function of the web application programs that may be selected; and provides the update data for transfer to the interface of the computer unit.

### CROSS-REFERENCE TO RELATED APPLICATIONS

This application claims priority under 35 U.S.C. §119 from German Patent Application No. DE 10 2011 006 898.8, filed Apr. 6, 2011, the entire disclosure of which is herein expressly incorporated by reference.

### BACKGROUND AND SUMMARY OF THE INVENTION

The invention relates to a method for operating a computer unit with a browser, which is assigned a web application program cache and which is assigned a configuration data file that specifies the web application programs that are to be stored in the cache. Furthermore, the invention relates to the computer unit and a device for operating an application portal and a corresponding device for operating an application portal and a system.

There is a growing demand to install so-called “infotainment” systems, which give the user the option of using a plurality of application programs, especially in motor vehicles. Such application programs may also include, for example, games. The current trend is to provide the application programs in the form of web application programs that can be requested with a browser. Therefore, it is important to make such web application programs easily available to an infotainment system in a motor vehicle.

The web site https://developer.mozilla.org/en/offline_ressources in Firefox provides information on how the Firefox browser can be used to assign to it an application program buffer memory (application cache), in which the program data of web application programs, which are noted in a so-called cache manifest, are stored and are updated by means of an on-line connection to the respective web address. If, on calling the respective web application program, an on-line connection is available, then the respective elements of the web application programs that are noted in the configuration data file are updated in the background; and otherwise the data stored in the application program cache are retrieved without the need for an on-line connection.

In addition, the web site http://www.whatwg.org/specs/web-apps/current-work/#offline describes how to create the so-called cache manifest. Furthermore, the web site http://developer. apple.com/safari/library/documentation/iPhone/Conceptual/SafariJ SDatabaseGuide/OfflineApplicationCache provides information regarding the implementation of the web application program cache using Safari 4.0.

The object of the present invention is to provide a method for operating a computer unit, a computer unit, a method and a device for operating an application portal and a system that is or are a contributing factor in making web application programs easily available in the computer unit.

This and other objects are achieved by a method for operating a computer unit with a browser, which is assigned a web application program cache and which is assigned a configuration data file that specifies the web application programs that are to be stored in the web application program cache and that are to be loaded from the cache without the presence of an on-line connection to a communications network, in order to execute the web application programs. The update data regarding the web application programs that are to be stored for the configuration data file are read in over an interface assigned to the computer unit; and the configuration data file is updated with the update data.

According to a first and a second aspect, the invention is characterized by a method for operating a computer unit with a browser, which is assigned a web application program cache and, furthermore, is assigned a configuration data file that specifies the web application programs that are to be stored in the cache and that are to be loaded from the cache without the presence of an on-line connection to a communications network, in order to execute the web application programs. The update data regarding the web application programs that are to be stored for the configuration data file can be read in over an interface assigned to the computer unit. The configuration data file is updated with the update data.

Corresponding thereto, the computer unit is provided, according to a second aspect, with a browser, which is assigned a web application program cache, and which is assigned a configuration data file that specifies the web application programs that are to be stored in the cache. For this purpose the computer unit is designed to read in the update data regarding the web application programs to be stored for the configuration data file over an interface, assigned to the computer unit, and to update the configuration data file with the update data.

This strategy allows the update data to be easily transferred in an automated manner into the configuration data file and also allows the update data to be made easily available, for example, by way of an application portal.

According to an advantageous embodiment of both the first and second aspects, the program data of the web application programs that are to be stored are made available over the interface, in particular, together with the update data; and the program data are stored in the cache. This feature eliminates the need for an on-line connection to a communications network, when the web application programs are used at a later date; otherwise the program data would have to be loaded at least initially over the communications network. As a result, this feature also enables the simple use of web application programs when the computer unit does not have a connection to a communications network; or only a limited data transfer is possible.

According to an additional embodiment of the first or the second aspect, the interface is designed to communicate directly with a data carrier, on which the update data and/or the program data are stored. This feature allows the update data and/or the program data to be read in over the interface in a very simple and easy way.

For example, the interface may be a USB interface, a Bluetooth interface or a WLAN interface.

According to a third and a fourth aspect, the invention is characterized by a method and a device, respectively, for operating an application portal. Web programs can be selected by way of the application portal; and these web programs are to be stored in a cache, which is assigned a browser, in a computer unit. The update data regarding the web application programs that are to be stored for the configuration data file are generated as a function of the web application programs that may be selected; and the configuration data file specifies the web application programs that are to be stored in the cache. The update data are provided for transfer to an interface of the computer unit. This feature makes it easy for the user of the computer unit to select the web application programs that he desires. Then, the corresponding update data are generated in an automated manner and made available for transfer to the interface of the computer unit. According to the third or the fourth aspect, the update data can then be easily further processed by the computer unit; and in this way then the configuration data file, which is assigned to the browser, can be updated.

According to an advantageous embodiment of both the third and fourth aspects, the program data of the web application programs to be stored are also made available as a function of the selected web application programs, in order to transfer the program data to the interface of the computer unit.

According to an additional embodiment of the third and fourth aspects, the application portal is assigned a portal interface, which is designed to communicate with a data carrier, in order to store the update data and/or the program data on the data carrier. For example, the portal interface can be a USB or Bluetooth interface. In this way the update data or the program data, respectively, can then be easily transferred to the interface of the computer unit so that there does not have to be a direct connection between the portal interface and the interface of the computer unit. This feature is especially advantageous, if the computer unit is not configured or is configured only to a limited degree to communicate with the application portal over a communications network.

According to a fifth aspect, the invention is characterized by a system with a device for operating the application portal according to the fourth aspect and for operating a computer unit according to the second aspect.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic block diagram of a first exemplary embodiment of a system; and

FIG. 2 is a second schematic block diagram of a exemplary embodiment of the system.

### DETAILED DESCRIPTION OF THE DRAWINGS

Elements of identical construction or function are identified with the same reference numerals throughout all of the figures.

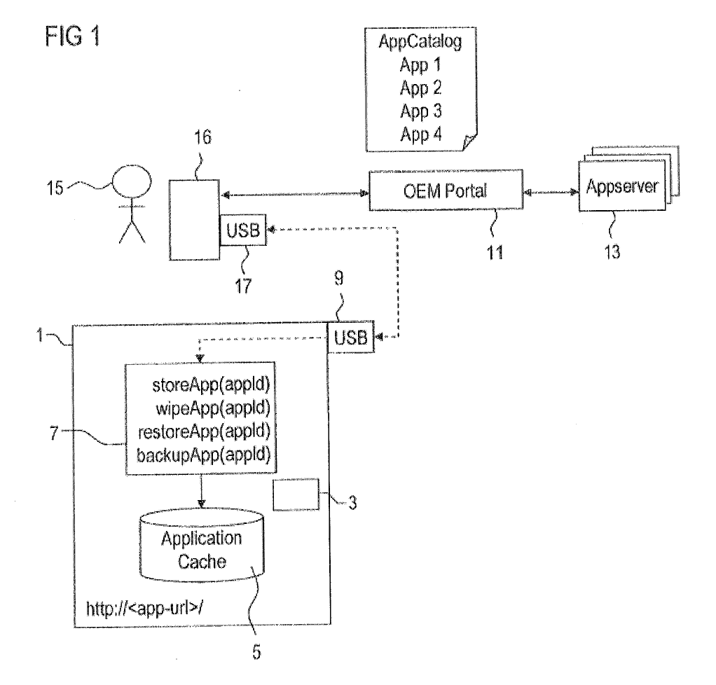

A system (FIG. 1) has a computer unit 1, which can also be called the head unit. The computer unit 1 has a browser 3, which is assigned an application program cache 5. Furthermore, there is a processing unit 7, which is designed to update a configuration data file with update data that are read in over an interface 9 of the computer unit. Furthermore, the processing unit 7 is also designed to process program data of the web application programs, which are to be stored and which are made available over the interface 9, and to store the program data in the application program cache. For this purpose, the processing unit 7 can execute, for example, a variety of functions, such as a function storeApp(appId) in order to store the corresponding program data in the application program cache 5, wipeApp(appId) in order to erase corresponding program data of the respective web application program in the application program cache 5 and/or restoreApp(appId) in order to restore, if desired, program data and/or backupApp(appId) in order to backup the respective program data.

Then, the computer unit 1 is operatively configured such that upon entering the corresponding web address of the respective web application program, represented here by “http://<app-url>/”, the respective application program is called as a function of the functionality of the browser for calling web application programs, which are stored in the web application program cache. As a result, this feature makes it possible, despite the absence of an on-line connection to a communications network, to retrieve the respective program data with respect to the web application program from the web application program cache 5; and, in so doing, the web application program can be made available to the user by way of the browser 3. In particular, the program data, which are stored in the web application program cache, comprise static components of the web application program. Static components of the web application program are, in particular, data for a graphical user interface or data for the program logic.

The interface 9 of the computer unit can be, for example, a USB interface or also a Bluetooth interface. It is even more preferred that the interface 9 be designed to communicate directly with a data carrier, on which the update data and/or the program data are stored. For example, the data carrier can be a USB stick.

Furthermore, the system comprises an application portal 11. The application portal 11 is designed in such a way that the application portal can be used to select the web application programs that are supposed to be useful in the computer unit 1. For this purpose, the user 15 can be offered a menu of possible web application programs by way of a graphical user interface; and the user can select from the menu the web application programs that are identified with App1, App2, App3 and App4 in FIG. 1. In this context there is, in particular, a user terminal device 16 with an optical output unit for the graphical user interface. The user terminal device 16 can be coupled to the application portal by way of a communications connection. The user terminal device 16 can be, for example, a PC or a Smartphone.

In this respect it is especially advantageous if the application portal 11 can communicate with an application server 13, on which, for example, the respective web application programs are stored—thus, in particular, program data of the web application programs.

After the user 15 has selected the corresponding web application programs that he desires, the application portal 11 generates the corresponding update data with respect to the web application programs that are to be stored for the configuration data file and makes the update data available for transfer to the interface 9 of the computer unit 1. For this purpose the application portal 11 is designed, for example, to make the update data available to a portal interface 17. Preferably the user 15 has access to this portal interface and can use this portal interface, for example, to store the update data on a portable data carrier and then to connect this data carrier at a later point in time to the interface 9 of the computer unit 1 and, in so doing, to transfer the update data into the computer unit 1. The portal interface 17 is also designed, for example, as a USB and/or Bluetooth interface. It can be, for example, a part of the user terminal device 16.

In addition, it is preferred that, furthermore, the application portal 11 be designed to provide additionally the corresponding program data with respect to the selected web application programs, in order to transfer the program data to the interface 9 of the computer unit 1 and, thus, to make these program data available to the portal interface 17. Then the program data can be transferred to the interface 9 of the computer unit 1, in particular, together with the update data, by use of the mobile data carrier.

This feature also makes it possible to call web application programs in the computer unit 11 by way of the browser 3, so that it is not absolutely mandatory that a connection to a communications network must be possible.

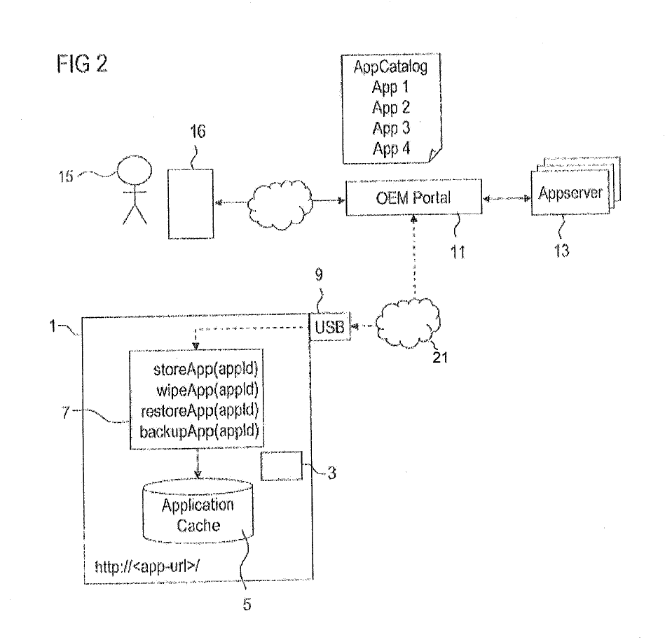

According to an additional exemplary embodiment of the system (FIG. 2), the application portal 11 can be coupled with the interface 9 of the computer unit 1 by way of a communications network 21. This feature also allows the corresponding update data and/or the program data to be transferred in an automated manner from the application portal 11 to the interface 9. For example, the web application program cache 5 can be filled with the respective program data by use of a so-called “push” mechanism. Such a so-called push can also be provided by the manufacturer—thus, for example, in the case of a vehicle—in the factory during manufacture of the vehicle.

Since the program data can be read in over the communications interface 9 of the computer unit 1 and thereafter these program data can be stored in the web application program cache 5 before the respective web application program is called by the respective user 15 in the computer unit 1, it is possible to minimize the start time of the web application program and also to enable the initial use of the web application program without an on-line connection.

A device for operating the application portal 11 can also comprise, for example, besides the application portal 11, the application server 13 and/or also the portal interface 17. Furthermore, it can also comprise a communications interface, over which the application portal 11 is coupled with the communications network 21.

List of Reference Numerals

1 computer unit

3 browser

5 application program cache

7 processing unit

9 interface of the computer unit

11 application portal

13 application server

App1-4 web application programs

15 user

16 user terminal device

17 portal interface

21 communications network

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method of operating a computer unit having a browser, the browser being assigned a web application program cache and a configuration data file specifying web application programs that are to be stored in the web application program cache, the method comprising the acts of:
loading the web application programs from the web application program cache without utilizing an on-line connection to a communication network in order to execute the web application programs;
reading-in over an interface assigned to the computer unit update data for the configuration data file, the update data concerning the web application programs that are to be stored; and
updating the configuration data file with the update data.

2. The method according to claim 1, further comprising the acts of:
making available program data of the web application programs over the interface; and
storing the program data in the web application program cache.

3. A computer unit equipped with a browser, the browser being assigned a web application program cache and a configuration data file specifying web application programs that are to be stored in the web application program cache and that are to be loaded from the web application program cache without use of an on-line connection to a communication network, the computer unit comprising:
a processing unit operatively configured to execute the web application programs, wherein:
said processing unit is operatively configured to read in update data regarding the web application programs that are to be stored for the configuration data file over an interface assigned to the computer unit; and
said processing unit is operatively configured to update the configuration data file with the update data.

4. The computer unit according to claim 3, wherein the interface is operatively configured to communicate directly with a data carrier on which at least one of the update data and program data is storable.

5. The computer unit according to claim 4, wherein the interface is one of a USB interface and a Bluetooth interface.

6. A method of operating an application portal, the method comprising the acts of:
selecting, via the application portal, a web application program to be stored in a web application program cache, said cache being assigned a browser in a computer unit;
generating update data regarding the web application program to be stored for a configuration data file as a function of the selected web application program, the configuration data file specifying the web application program to be stored in the web application program cache and to be loaded from the cache without using an on-line connection to a communication network, in order to execute the web application program; and
providing the update data for transfer to an interface of the computer unit.

7. The method according to claim 6, wherein program data of the web application program to be stored are made available as a function of the selected web application program, in order to transfer the program data to the interface of the computer unit.

8. A device for operating an application portal, the device comprising:
a first module by which web application programs are selectable via the application portal, the web application programs being stored in a web application program cache, which is assigned a browser, in a computer unit;
a second module by which update data regarding the web application programs that are to be stored for a configuration data file are generated as a function of the selectable web application programs, said configuration data file specifying the web application programs that are to be stored in the web application cache and that are to be loaded from the cache without using an on-line connection to a communication network, in order to execute the web application programs; and
wherein the update data are provided for transfer to an interface of the computer unit.

9. The device according to claim 8, further comprising:
a portal interface assigned to the application portal, the portal interface being operatively configured to communicate with a data carrier in order to store at least one of the update data and program data on the data carrier.

10. A system, comprising:
a device for operating an application portal, wherein the device is operatively configured such that web application programs are selectable via the portal for storage in a web application cache;
a computer unit equipped with a browser, the browser being assigned the web application program cache and a configuration data file specifying the web application programs that are to be stored in the web application program cache and that are to be loaded from the web application program cache without use of an on-line connection to a communication network;
wherein the computer unit comprises a processing unit operatively configured to execute the web application programs, the processing unit being operatively configured to read-in update data regarding the web application programs that are to be stored for the configuration data file over an interface assigned to the computer unit, and to update the configuration data file with the update data.
